(19) United States
(12) Patent Application Publication
(10) Pub. No.: US 2012/0011200 A1
(43) Pub. Date: Jan. 12, 2012

(54) METHOD AND APPARATUS FOR DATA STORAGE IN A PEER-TO-PEER NETWORK

(75) Inventors: Xinyan Zhang, Nanjing (CN); Li Zhou, Bellevue, WA (US)

(73) Assignee: ROXBEAM MEDIA NETWORK CORPORATION, Beijing (CN)

(21) Appl. No.: 13/176,498

(22) Filed: Jul. 5, 2011

Related U.S. Application Data
(60) Provisional application No. 61/361,647, filed on Jul. 6, 2010.

(51) Int. Cl. G06F 15/16

(52) U.S. Cl. 709/204

(57) ABSTRACT

One embodiment of the present invention provides a peer-to-peer (P2P) data-storage system. The system includes a P2P network, a file upload module configured to receive a file uploaded by a user, a file processing module configured to disassemble the received file into a plurality of file blocks and select a plurality of peer nodes from the P2P network, and a file distribution module configured to distribute the file blocks to the selected peer nodes. A respective file block is distributed to a respective peer node.

### RELATED APPLICATION

This application claims the benefit of U.S. Provisional Application No. 61/361,647, Attorney Docket Number ROX10-1001PSP, entitled “P2P STORAGE SYSTEM,” by inventors Xinyan Zhang and Li Zhou, filed Jul. 6, 2010.

### BACKGROUND

1. Field

The present disclosure relates to online data storage. More specifically, the present disclosure relates to online data storage in a peer-to-peer (P2P) network.

2. Related Art

The ubiquity of computers and digital-formatted data has fueled the need for secure and reliable data-storage solutions. Traditional data-storage solutions rely on locally built storage hardware. However, data stored in such locally built hardware is vulnerable to equipment failure and natural disasters. Online data storage allows individuals or businesses to outsource their data-storage needs to a third-party storage service provider. In addition, online data storage allows a user to access data from any computer having web access. Recently, cloud storage has gained popularity among business users. A typical cloud storage system stores user data in geographically dispersed data centers and serves up the closest copy of that data when the user needs it. However, data centers are expensive to build and hard to maintain. It is desirable to provide a more cost-effective data-storage solution.

Peer-to-peer overlay (P2P) networks have attracted growing interest as one solution for content distribution. A P2P network operates over a conventional network-layer infrastructure, such as the Internet, and peer nodes are “aware” of the states of other peer nodes. Content delivery is not undertaken by one particular server. Instead, a group of peer nodes directly exchange data or services among themselves. Thus, P2P networks provide a favorable environment for delivering large amounts of data because server overloading is avoided and network congestion is reduced. P2P networks also scale gracefully as the number of users increases.

### SUMMARY

One embodiment of the present invention provides a peer-to-peer (P2P) data-storage system. The system includes a P2P network, a file upload module configured to receive a file uploaded by a user, a file processing module configured to disassemble the received file into a plurality of file blocks and select a plurality of peer nodes from the P2P network, and a file distribution module configured to distribute the file blocks to the selected peer nodes. A respective file block is distributed to a respective peer node.

In a variation on this embodiment, the peer nodes include at least one of: a plug computer, a desktop computer, a set top box, and a wireless router.

In a variation on this embodiment, the system further includes a replication module configured to generate multiple copies of the respective file block. The file distribution module is further configured to distribute each copy to a different peer node, thereby resulting in the multiple copies of the respective file block being downloaded to multiple different peer nodes.

In a further variation, the replication module is further configured to monitor the multiple different peer nodes. In response to at least one of the multiple different peer nodes becoming unreachable, the replication module is configured to identify a file block stored in the unreachable peer node and replicate the identified file block. The file distribution module is configured to distribute the replicated file block to a different peer node in the P2P network.

In a variation on this embodiment, the system includes an encryption module configured to encrypt the received file.

In a variation on this embodiment, the system includes a tracker module configured to maintain a tracker file. The tracker file includes index information associated with the file blocks and the selected peer nodes.

In a variation on this embodiment, the system includes a log module configured to maintain a log file.

In a variation on this embodiment, the system includes a tunnel module. In response to a selected peer node being behind a firewall, the tunnel module is configured to establish a tunnel to the selected peer node.

In a variation on this embodiment, the system includes an event module configured to notify a selected peer node that a file block is scheduled for distribution.

### BRIEF DESCRIPTION OF THE FIGURES

FIG. 1 presents a diagram illustrating the architecture of an exemplary peer-to-peer (P2P) data-storage system in accordance with an embodiment of the present invention.

FIG. 2 presents a diagram illustrating details of the storage-system server cluster, in accordance with an embodiment of the present invention.

FIG. 3 presents a flow chart illustrating the process of using the P2P data-storage system for backing up a file, in accordance with an embodiment of the present invention.

FIG. 4 presents a flow chart illustrating the process of recovering a file stored in the P2P data-storage system, in accordance with an embodiment of the present invention.

FIG. 5 presents a diagram illustrating the process of distributing a file block to a peer storage node that is behind a firewall, in accordance with an embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention (e.g., general passive optical network (PON) architectures). Thus, the present invention is not intended to be limited to the embodiments shown, but is to be accorded the widest scope consistent with the principles and features disclosed herein.

### Overview

Embodiments of the present invention provide an online data-storage system based on peer-to-peer (P2P) networks. In the P2P-based data-storage system, user data are stored in P2P nodes, such as plug computers, distributed in various locations, such as individual homes and businesses. A user first uploads the data to a file upload server, which stores the data temporarily. Subsequently, the data are replicated, encoded, and sometimes encrypted. The encoded and encrypted data is then divided into a number of data blocks, and each data block is distributed to a particular user device belonging to the P2P network. When the user requests the data, the system locates the data blocks distributed to the various user devices, and reassemble the original data file from the data blocks.

### System Architecture

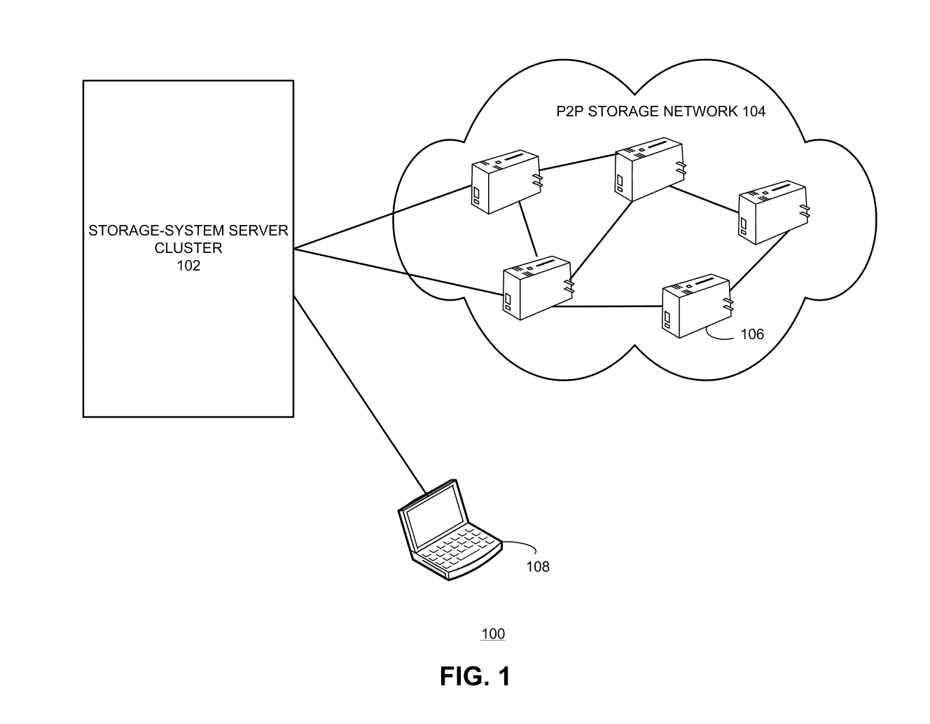

FIG. 1 presents a diagram illustrating the architecture of an exemplary peer-to-peer (P2P) data-storage system, in accordance with an embodiment of the present invention. P2P data-storage system 100 includes a storage-system server cluster 102, a P2P network 104, and a client computer 108.

Storage-system server cluster 102 includes a number of servers, each server providing a certain function/service that facilitates data storage over P2P storage network 104.

P2P storage network 104 includes a number of peer storage nodes, such as P2P storage node 106. A peer storage node can be any device capable of receiving/transmitting and storing data. In addition, to ensure data availability, it is preferable to have as a peer storage node a device that is powered up at all times, or most of the time, such as a plug computer. Other computing devices, such as a desktop computer, a wireless router with data-storage capability, or a set top box, can also function as a storage peer node given that they can be powered up most of the time. The P2P storage network 104 can be formed as a logical layer over an existing network infrastructure, for example, the Internet or a wireless cellular network. The underlying network can be implemented in accordance with the Internet Protocol (IP), such as described in W. R. Stevens, “TCP/IP Illustrated,” Vol. 1, Ch. 1, et seq., Addison-Wesley (1994), the disclosure of which is incorporated by reference herein. Other network infrastructures are possible.

Client computer 108 can be any device capable of receiving or transmitting data, such as a cell phone, a personal data assistant (PDA), a laptop computer, and a desktop computer. Depending on the platform, mainly personal computers (PCs) or mobiles, various applications can be developed to allow a user to obtain the storage and services provided in P2P storage system 100 via client computer 108.

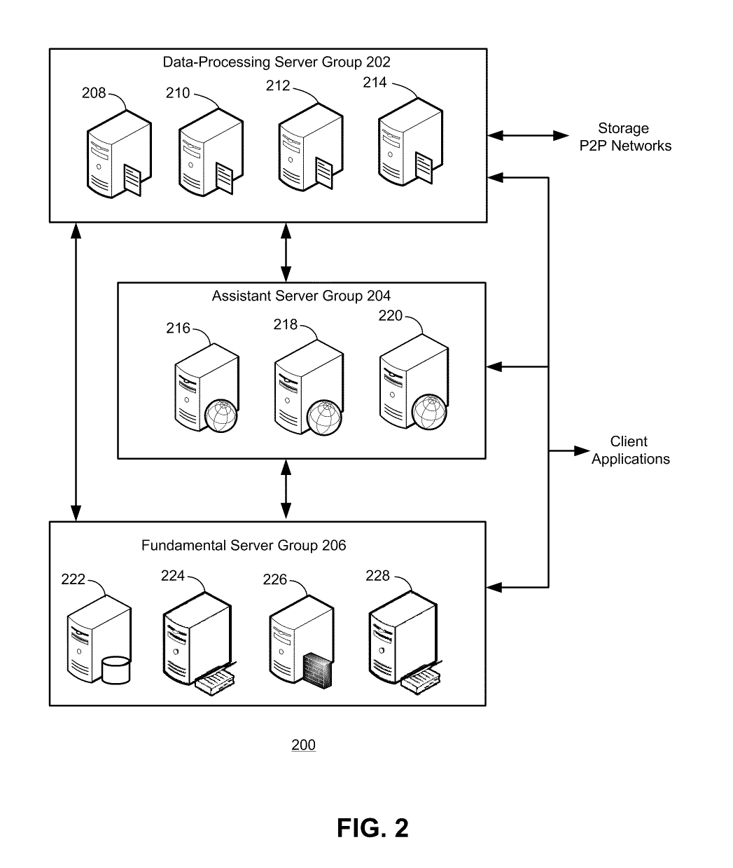

FIG. 2 presents a diagram illustrating details of the storage-system server cluster, in accordance with an embodiment of the present invention. Storage-system server cluster 200 includes three server groups, data-processing server group 202, assistant server group 204, and fundamental server group 206.

Data-processing server group 202 handles various types of file operations, including file uploading/downloading, file encryption/decryption, file coding/decoding, file scattering, file block distribution, etc. Data-processing server group 202 includes a number of servers, such as a file upload/download server 208, a data replication server 210, a file processing server 212, and an event server 214.

File upload/download server 208 handles the uploading and downloading of the user data files. On one hand, it provides upload service to client applications by accepting uploaded original files for file backup; on the other hand, it provides download service to the peer storage nodes by allowing them to download the correct file blocks as scheduled.

Data replication server 210 provides data replication functions that can avoid single-point failure. During operation, data replication server 210 analyzes the dissemination information of the stored contents and the connectivity and the reachability of the peer storage nodes storing portions of the files. In one embodiment, data replication server 210 monitors the condition of all peer storage nodes in order to determine whether the desired redundancy level is maintained. In the event of one or more peer storage nodes becoming unreachable, either due to equipment failure or being powered off, data replication server 210 evaluates the redundancy level of the particular file portion stored at the failed nodes. If the redundancy level is lower than a predetermined threshold, data replication server 210 will generate replications of the particular file portion and scatter those replications to other peer storage nodes that are in good condition. For example, due to a power outage in a large area, a number of plug computers become offline; data replication server 210 detects that the number of reachable copies for a certain file fragment is now smaller than a predetermined value, such as five. Consequently, data replication server 210 generates multiple copies of the particular piece of file fragment and scatters these multiple copies on multiple other plug computers that are not affected by the power outage.

File processing server 212 provides the core function of operating on the original files that are uploaded by the client application. The file operations include, but are not limited to: file encryption, file coding, scheduling suitable peer storage nodes for each file block, and triggering event server 214 for file downloading. Note that before the files are disassembled into individual blocks, for security purposes, the files are encrypted. Various known data encryption methods, such as public key cryptography, can be used to encrypt the user files. In addition, the original file is also encoded for error protection purposes. In one embodiment, the original file is encoded using a Reed-Solomon (RS) code. File processing server 212 is also responsible for dividing the encoded/encrypted file into individual blocks, selecting suitable peer storage nodes, and scheduling downloading of each file block.

Event server 214 provides a task notification channel to inform each peer storage node when there is a task assigned to it. The task can be either downloading a corresponding file block from file upload/download server 208 or uploading a file or file block to file upload/download server 208. Once a peer node finishes the assigned task, it reports back to event server 214.

Assistant server group 204 includes a number of servers that provide basic services for the P2P storage system, these services including, but not limited to: application updating, system logging, and system monitoring. Assistant server group 204 includes a number of servers, such as an update server 216, a log server 218, and a monitoring server 220.

Update server 216 provides an auto updating service to all peer storage nodes. The peer storage nodes periodically contact update server 216 to query available updates and automatically download higher versions of peer-side software. After the successful installation of the peer-side software, a peer storage node re-launches the corresponding P2P storage program.

Log server 218 provides log collection service. During operation, the peer storage nodes report to log server 218 important events, such as file downloads and uploads. Log server 218 stores the event information permanently. In addition, log server 218 can provide an interface to other third-party software to allow the user to view the system log.

Monitoring server 220 provides system-monitoring service in order to make sure each system server works smoothly. During operation, monitoring server 220 provides necessary information to the system operator when the P2P storage system is in irregular situations. Monitoring server 220 ensures that all system servers can work stably while cooperating with each other.

Fundamental server group 206 provides basic functions that support file operations. These functions include, but are not limited to: database service, user authentication, and peer-connection service.

Database server 222 provides database service to all other servers in the P2P storage system. For example, information regarding location of the peer nodes and individual file block storage can be maintained by database server 222. Various types of database systems can be used by database server 222. In one embodiment, database server 222 uses MySQL™ (trademark of MySQL AB of Uppsala, Sweden).

Tracker server 224 provides indexing service of the stored file content by maintaining information regarding which file block is stored on which peer storage node. Using this piece of information, a peer node or a client application will know how to accumulate needed blocks for recovering the original file. In addition, tracker server 224 maintains a list of available storage nodes and can provide such a list to a peer node or a client upon request. In one embodiment, tracker server 224 can present a user interface to allow the user to view the file tracking information. For example, the user interface may allow the user of the P2P storage system to view the IP address of the peer nodes storing portions of the data files.

Tunnel server 226 provides relaying services to peer storage nodes when needed. For example, some peer nodes may be behind a network address translation (NAT) firewall and are thus, unreachable by other peer nodes or the client computer. Tunnel server 226 can then establish tunnels to the unreachable peer nodes, and relay data to the unreachable peer nodes through the tunnels. In addition, tunnel server 226 can also assist the UDP (user datagram protocol) hole-punching procedure to allow two peer nodes communicate across NAT firewalls.

Session server 228 provides end user authentication services. For example, when an end user tries to access one of the peer nodes via a client computer, such as a smartphone, the peer node will communicate with session server 228 on behalf of the end user. If the access is cleared, session server 228 generates a session ID and returns the session ID to the end user.

Note that, although FIG. 2 shows a server cluster including 11 different servers for providing different services, the number of servers and the number of services can be different. In addition to having different system servers to provide different system services, it is also possible to have a centralized server perform all the aforementioned services, or to have a reduced number of servers, each performing multiple services. For example, services provided by the four servers in data-processing server group 202 can also be provided by a single system server. In addition, grouping the servers into different server groups based on their functions is merely for description purposes; in practice, a system server may be able to provide services selected from different server groups.

### File Backup and Recovery

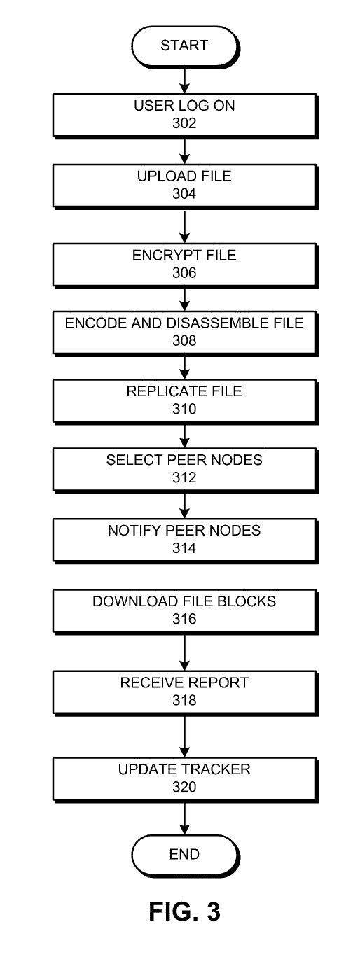

FIG. 3 presents a flow chart illustrating the process of using the P2P data-storage system for backing up a file, in accordance with an embodiment of the present invention.

During operation, a user logs on the session server, which starts a session and generates a session ID (operation 302). The user then uploads the file for backup to the file upload/download server, which temporarily stores the file (operation 304). Subsequently, the file processing server encrypts the file for security purposes (operation 306). In one embodiment, data encryption based on the Advanced Encryption Standard (AES) is performed. In a further embodiment, an encryption key is generated and stored in the database server. The file processing server further encodes and disassembles the file into a number of file blocks (operation 308). The file replication server makes multiple copies of each file block to provide redundancy (operation 310). For example, an encrypted/encoded user file can be divided into 10 file blocks, and each block can have three copies, resulting in 30 file blocks all together. Then, the file processing server selects 30 suitable peer storage nodes from all available peer nodes in the P2P network (operation 312). A suitable peer storage node is a node that is in good condition, including having sufficient storage capacity and being reachable. The selected peer storage nodes are geographically dispersed to avoid losing data in the event of natural disaster.

Once the peer nodes are identified, the event server will notify the identified peer nodes of the pending downloading task (operation 314), and each notified peer node subsequently downloads a corresponding file block from the file upload/download server (operation 316). Note that, after all file blocks are downloaded to corresponding storage peer nodes, the file upload/download server will delete the user file. After a peer node finishes downloading, it reports back to the event server (operation 318). Accordingly, the tracker server updates the tracker file associated with the particular file block (operation 320).

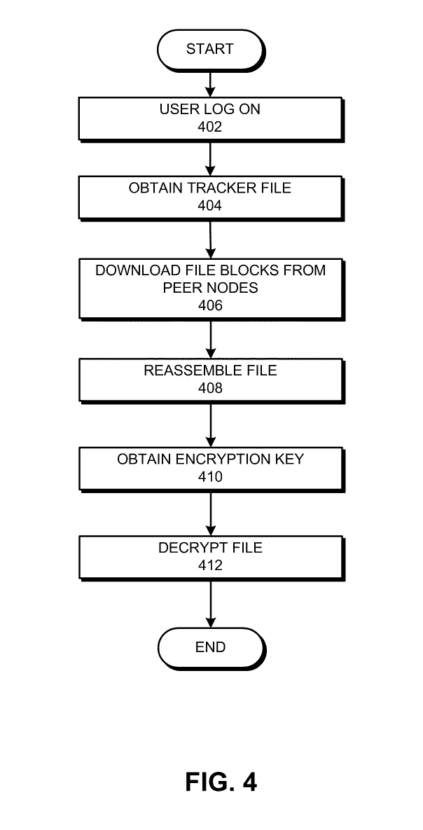

FIG. 4 presents a flow chart illustrating the process of recovering a file stored in the P2P data-storage system, in accordance with an embodiment of the present invention.

During operation, to recover a file from the P2P data-storage system, a user first logS on the session server via a client computer (operation 402). The session server starts a session and generates a session ID for this session. The client computer connects to the tracker server to obtain the tracker file associated with the desired file (operation 404). Note that the tracker file contains information regarding which portion of the file is stored in which peer node, including the IP addresses of the peer nodes.

After obtaining the IP addresses of the peer nodes storing portions of the file, the client computer starts downloading individual file blocks from those peer nodes (operation 406). Note that allowing the client computer to download file blocks directly from peer nodes instead of from a server prevents server congestion. In one embodiment, the client computer attempts to connect to all peer nodes storing the desired file blocks. In one embodiment, the client computer only connects to the peer nodes that are close by. In the event that a peer node is behind a NAT firewall, thus being unreachable, the tunnel server will download the file block from that peer node and relay the downloaded file block back to the client computer.

Using the tracker file as an index, the client computer reassembles the encrypted file using downloaded blocks (operation 408). In one embodiment, the downloading and the reassembling operations are performed concurrently. In other words, the file is being put back together as individual file blocks are downloaded. Once a complete copy of the encrypted file becomes available, the client computer will stop its downloading operation.

Note that the reassembled file is encrypted. To fully recover the original file, the client computer also needs to obtain the encryption key (operation 410). In one embodiment, the client computer obtains the encryption key from the database server. The client computer finally decrypts the file using the obtained key to recover the original file (operation 412).

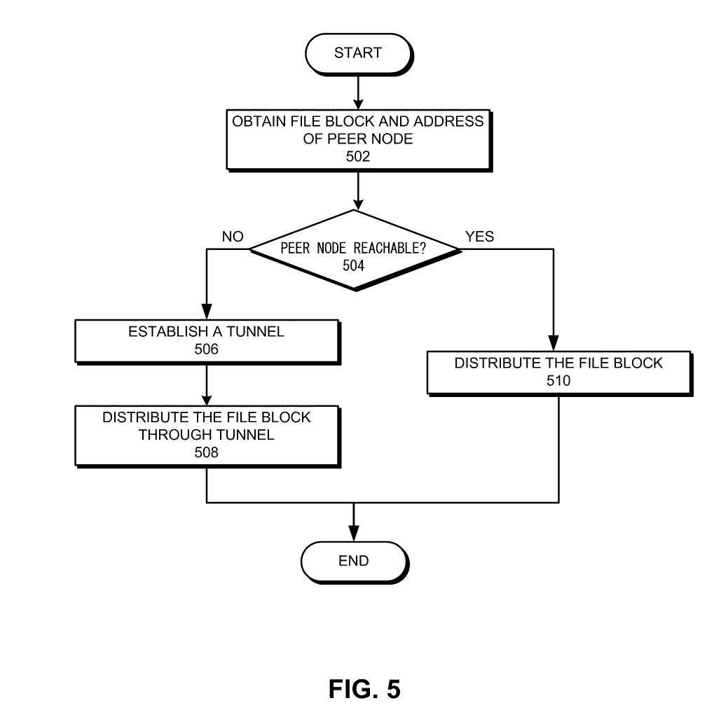

FIG. 5 presents a diagram illustrating the process of distributing a file block to a peer storage node that is behind a firewall, in accordance with an embodiment of the present invention. During operation, the system obtains a file block and the address of a peer storage node selected to store the file block (operation 502). The file block is a fragment of the encrypted/encoded file, and the address can be an internet protocol (IP) address of the peer storage node. The system determines whether the peer storage node is reachable directly, i.e., whether it is behind a firewall, such as a NAT box (operation 504). If not, the system establishes a tunnel to the peer node (operation 506), and distributes the file block to the peer node through the tunnel (operation 508). In one embodiment, NAT traversal is performed to facilitate the establishment of the tunnel. If the peer storage node is reachable, the system distributes the file block directly (operation 510).

In addition to the file backup and file recovery functions, the P2P storage system also includes other assisting functions that provide storage redundancy, file security, system logging, and automatic system updating. Storage redundancy is achieved by storing additional copies of each file block at different peer storage nodes. File security is provided by data encryption. The fact that the file is disassembled and stored at different locations provides an additional level of security because, without knowing how the file is disassembled and where the individual file blocks stored, an authorized user cannot recover the original file. The system log is collected by a log server, and the automatic update is managed by an update server.

Compared with the conventional cloud storage system, the P2P data-storage system has a number of advantages. In the cloud storage system, copies of the original file are stored at various, geographically dispersed data centers. In other words, a particular data center maintains a copy of the entire file. Therefore, if that data center is hacked, that user file might also be tempered with. In contrast, in the P2P data-storage system, a certain peer storage node only holds a fragment of the original file. Hence, even if the peer storage node is hacked by a malicious user, the malicious user cannot obtain the entire user file without knowing the location of other file fragments and how they can be reassembled. In addition, the peer storage nodes are much cheaper to acquire and maintain in comparison with the servers in the data center. The upload/download server only maintains a copy of the uploaded user file temporarily, thus need not have a large storage capacity. When the user needs to access the stored file, he can download blocks of the file from various peer nodes, thus avoiding server congestion and making the process of downloading a large file much faster.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for storing data in a peer-to-peer (P2P) network, comprising:
receiving a file uploaded by a user;
disassembling the received file into a plurality of file blocks;
selecting a plurality of peer nodes from the P2P network; and
distributing the file blocks to the selected peer nodes, wherein a respective file block is distributed to a respective peer node, and wherein distributing the respective file block to the respective peer node further involves:
determining whether the respective peer node is behind a firewall; and
in response to the selected peer node being behind a firewall, establishing a tunnel.

2. The method of claim 1, wherein the peer nodes include at least one of:
a plug computer;
a desktop computer;
a set top box; and
a wireless router.

3. The method of claim 1, further comprising:
generating multiple copies of the respective file block; and
distributing each copy to a different peer node, thereby resulting in the multiple copies of the respective file block being distributed to multiple different peer nodes.

4. The method of claim 3, further comprising:
monitoring the multiple different peer nodes;
in response to at least one of the multiple different peer nodes becoming unreachable:
identifying a file block stored in the unreachable peer node;
replicating the identified file block; and
storing the replicated file block in a different peer node in the P2P network.

5. The method of claim 1, further comprising encrypting the received file.

6. The method of claim 1, further comprising maintaining a tracker file, wherein the tracker file includes index information associated with the file blocks and the selected peer nodes.

7. The method of claim 1, further comprising maintaining a log file.

8. The method of claim 1, wherein distributing the file blocks to the selected peer nodes involves:
notifying a selected peer node that a file block is scheduled for distribution; and
allowing the selected peer node to download the scheduled file block.

9. A peer-to-peer (P2P) data-storage system, comprising:
a P2P network;
a file upload module configured to receive a file uploaded by a user;
a file processing module configured to:
disassemble the received file into a plurality of file blocks; and
select a plurality of peer nodes from the P2P network;
a file distribution module configured to distribute the file blocks to the selected peer nodes, wherein a respective file block is distributed to a respective peer node; and
a tunnel module configured to establish a tunnel to a selected peer node that is behind a firewall.

10. The P2P data-storage system of claim 9, wherein the peer nodes include at least one of:
a plug computer;
a desktop computer;
a set top box; and
a wireless router.

11. The P2P data-storage system of claim 9, further comprising a replication module configured to generate multiple copies of the respective file block, and wherein the file distribution module is further configured to distribute each copy to a different peer node, thereby resulting in the multiple copies of the respective file block being downloaded to multiple different peer nodes.

12. The P2P data-storage system of claim 11, wherein the replication module is further configured to:
monitor the multiple different peer nodes;
in response to at least one of the multiple different peer nodes becoming unreachable:
identify a file block stored in the unreachable peer node; and
replicate the identified file block; and
wherein the file distribution module is configured to distribute the replicated file block to a different peer node in the P2P network.

13. The P2P data-storage system of claim 9, further comprising an encryption module configured to encrypt the received file.

14. The P2P data-storage system of claim 9, further comprising a tracker module configured to maintain a tracker file, wherein the tracker file includes index information associated with the file blocks and the selected peer nodes.

15. The P2P data-storage system of claim 9, further comprising a log module configured to maintain a log file.

16. The P2P data-storage system of claim 9, further comprising an event module configured to notify a selected peer node that a file block is scheduled for distribution.

17. A non-transitory computer-readable storage medium storing instructions which when executed by a computer cause the computer to perform a method for storing data in a peer-to-peer (P2P) network, the method comprising:
receiving a file;
disassembling the received file into a plurality of file blocks;
selecting a plurality of peer nodes from the P2P network; and
distributing the file blocks to the selected peer nodes, wherein a respective file block is distributed to a respective peer node, and wherein distributing the respective file block to the respective peer node further involves:
determining whether the respective peer node is behind a firewall; and
in response to the selected peer node being behind a firewall, establishing a tunnel.

18. The computer-readable storage medium of claim 17, wherein the peer nodes include at least one of:
a plug computer;
a desktop computer;
a set top box; and
a wireless router.

19. The computer-readable storage medium of claim 17, wherein the method further comprises:
generating multiple copies of the respective file block; and
distributing each copy to a different peer node, thereby resulting in the multiple copies of the respective file block being distributed to multiple different peer nodes.

20. The computer-readable storage medium of claim 19, wherein the method further comprises:
monitoring the multiple different peer nodes;
in response to at least one of the multiple different peer nodes becoming unreachable:
identifying a file block stored in the unreachable peer node;
replicating the identified file block; and
storing the replicated file block in a different peer node in the P2P network.

21. The computer-readable storage medium of claim 17, wherein the method further comprises encrypting the received file.

22. The computer-readable storage medium of claim 17, wherein the method further comprises maintaining a tracker file, wherein the tracker file includes index information associated with the file blocks and the selected peer nodes.

23. The computer-readable storage medium of claim 17, wherein the method further comprises maintaining a log file.

24. The computer-readable storage medium of claim 17, wherein distributing the file blocks to the selected peer nodes involves:
notifying a selected peer node that a file block is scheduled for distribution; and
allowing the selected peer node to download the scheduled file block.
